(19) United States
(12) Patent Application Publication
(10) Pub. No.: US 2026/0257660 A1
(43) Pub. Date: Sep. 3, 2026

(54) A COMPUTER-IMPLEMENTED METHOD FOR PROVIDING STEERING CONTROL FOR AN AUTONOMOUSLY DRIVEN OR SEMI-AUTONOMOUSLY DRIVEN VEHICLE

(71) Applicant: AUMOVIO Autonomous Mobility Germany GmbH, Ingolstadt (DE)

(72) Inventor: Jiaqi YAN, Langen (DE)

(73) Assignee: AUMOVIO Autonomous Mobility Germany GmbH, Ingolstadt (DE)

(21) Appl. No.: 19/164,038

(22) PCT Filed: Mar. 13, 2024
(86) PCT No.: PCT/EP2024/056596

§ 371 Date: Sep. 10, 2025

(30) Foreign Application Priority Data
Mar. 14, 2023 (DE) 10 2023 202 285.0

(51) Int. Cl. B60W 10/20; B60W 30/12; B60W 50/00; B60W 50/14; B60W 60/00

(52) U.S. Cl. CPC B60W 10/20; B60W 30/12; B60W 50/14; B60W 60/001; B60W 60/0053; B60W 2050/0028; B60W 2420/403; B60W 2420/408; B60W 2420/54

(57) ABSTRACT

A method for providing steering control for an autonomously driven or semi-autonomously driven vehicle, includes: receiving sensor data corresponding to a roadway of the driven vehicle, determining a first target point ahead of the driven vehicle, determining a second target point lying on the same lateral plane as the first target point when the vehicle has travelled for a time after the time of the determined first target point and/or determining the second target point lying on the same lateral plane as the first target point when the vehicle has travelled a predefined distance, calculating a lateral distance between the determined first and second target point, comparing the calculated distance with at least a first predefined threshold, determining a path tracking error if the calculated lateral distance exceeds at least the first predefined threshold. A control signal to a steering controller is provided in dependence of the determined tracking error.

### CROSS REFERENCES TO RELATED APPLICATIONS

This application is the U.S. National Phase Application of PCT International Application No. PCT/EP2024/056596, filed Mar. 13, 2024, which claims priority to German Patent Application No. 10 2023 202 285.0, filed Mar. 14, 2023, the contents of such applications being incorporated by reference herein.

### FIELD OF THE INVENTION

The invention relates to a computer-implemented method and a driver assistance system for an autonomously driven or semi-autonomously driven vehicle, a program element, and a computer-readable medium, a driver assistance system and a vehicle comprising the driver assistance system.

### BACKGROUND OF THE INVENTION

Modern driver assistance systems can assist the driver by performing certain driving functions or can autonomously drive the vehicle without the need of any further interventions by the driver. Autonomous driving systems include a lateral vehicle control system such as lane centering and lane keeping systems in order to keep the vehicle within a driving lane.

U.S. Pat. No. 9,428,187 B2, incorporated herein by reference, discloses a system and method for providing path planning and generation for automated lane centering for a vehicle traveling on a roadway, where the method employs roadway measurement values from a vision camera within an effective range of the camera and roadway measurement values from a map database beyond the range of the camera. The method uses the roadway measurement values from the camera to determine a desired path along a first segment of the roadway and identifies an end of the first segment based on how accurately the camera defines the roadway. The camera estimates the position and orientation of the lane with respect to the center of the vehicle by points. For example, the roadway is modeled as two sections of second order polynomial equations.

Camera vision may be limited in its ability to detect the lane path due to roadway curvature. Moreover, the ego-motion of the vehicle can generate additional position error in the mathematical transformation from image to world-space. Therefore, the detected or fused lane model may not provide the required accuracy for path prediction for autonomous or semi-autonomous driving systems. Critical driving situations resulted by an inaccurate lane model may be a consequence.

### SUMMARY OF THE INVENTION

Correspondingly, there is a need for an improved method for a reliable autonomous or semi-autonomous vehicle guidance.

It shall be noted that all embodiments of the present invention concerning a method, might be carried out with the order of the steps as described, nevertheless this has not to be the only and essential order of the steps of the method. The herein presented methods can be carried out with another order of the disclosed steps without departing from the respective method embodiment, unless explicitly mentioned to the contrary hereinafter.

According to a first aspect, a computer-implemented method for providing steering control for an autonomously driven or semi-autonomously driven vehicle is provided. In this context, the term “semi-autonomous driving” means that one or more driving functions of the driver are taken over by a driver assistance system of the vehicle. The term “autonomous driving” means that all driving functions are performed by the driver assistance system.

The method comprises following steps. First, sensor data corresponding to a roadway of the driven vehicle is received from at least one vehicle sensor. For example, the vehicle sensor may be a camera capturing images of the roadway for extracting lane parameters.

As a next step, a first target point ahead of the driven vehicle is determined. In particular, the first target point is a desired position to which the vehicle is to be guided. For example, the location of the first target point is on the centerline of the ego-lane. The determination of the first target point can be dependent on multiple factors like planning strategy, system delays etc. In particular, the longitudinal distance between the first target point and the current vehicle position at the time of determining the first target point may depend on an absolute distance value, for example 60 meters, and/or a time-based value which is depending on the current vehicle velocity, for example 2 seconds.

According to an aspect of the invention, a second target point lying on the same lateral plane as the first target point is determined when the vehicle has travelled for a certain time after the time of the determined first target point and/or when the vehicle has travelled a predefined longitudinal distance. In this context, the term “same lateral plane” means that both points need not be achieved exactly, but that tolerances, measurement accuracy limitations and other factors known to those of skill in the art, may occur in amounts that do not preclude the effect the characteristic was intended to provide. In particular, the determination of the second target point takes place when the vehicle has reached the determined first target point or at least is close to the determined first target point. The term “close” to the determined first target point means in near range to the first target point, for instance a longitudinal distance of about or less than 1 meter between the current driven vehicle position and the first target point. Since the sensor detection, in particular the images provided by a vehicle camera, is usually very accurate in near range to the vehicle. Therefore, the determined second target point can advantageously be considered as pseudo ground truth.

As a next step, a lateral distance between the determined first and second target point is calculated, wherein the calculated lateral distance is compared with at least a first predefined threshold. A path tracking error is determined if the calculated lateral distance exceeds at least the first predefined threshold. By doing this, a reliable consistency check of the lane model is obtained.

Next, a control signal to a steering controller is provided in dependence of the determined tracking error. In particular, if a tracking error has been determined, a degradation of the steering control, preferably of a lane keeping assist, will follow.

The benefit of this lane model consistency is to reduce the potential risk of having erroneous steering behaviors due to not detectable misdetection of lane model from sense and fusion. The information required for identifying the accuracy of the lane model are determined in an easy and resource-efficient manner.

According to an embodiment, the determined lateral distance is either a single determined value and/or a calculated average from multiple determined lateral distance values. For example, the lateral distance can be checked at regular intervals. Such intervals may be predetermined computing cycles, image cycles or longitudinal distances.

According to another preferred embodiment, the calculated lateral distance is compared with at least a second predefined threshold, wherein the second predefined threshold is higher than the first predefined threshold. Preferably, a first steering control signal is provided, if the first predefined threshold exceeds, and wherein a second steering control signal is provided, if the second predefined threshold exceeds. Further, the first and second predefined control signal may differ at least in part from each other. In particular, the second predefined control signal gives stricter restrictions on the autonomous or semi-autonomous driving than the first predefined control signal.

For instance, a hand-off time of the steering wheel will be reduced and/or the driver will be informed that the current steering control system might not be stable and/or a threshold for intervention in the steering control system by the driver will be reduced if the calculated lateral distance exceeds the first predefined threshold for longer than a predefined time. By taking the time threshold into account, a simple measurement error can be eliminated. Reducing the hands-off time and/or informing the driver in the event of expected inaccurate trajectory guidance ensures that the driver can take over in a timely manner.

According to a further embodiment, the driver will receive a take-over request and/or the steering control will be ended in a predefined time if the calculated lateral distance exceeds the second predefined threshold for longer than a predefined time. Giving the driver the take-over driving obligation in the event of clearly expected inaccurate trajectory tracking prevents misleading steering control.

According to a further embodiment, the first target point is received and stored from a lane model as lateral and longitudinal cartesian coordinates. In other words, a location of the first target point is directly measured in relative coordinates and then transformed to absolute coordinates. The coordinate system may be sent from sense or fusion via a mathematical model, e.g., polynomial, clothoid or polyline model. Further, the first cartesian target point may be transformed into a global coordinate system as three-dimensional location coordinates of the vehicle.

According to a further embodiment, the second target point is received and stored from the lane model as lateral and longitudinal cartesian coordinates, wherein the second cartesian target point is transformed as three-dimensional location coordinates of the vehicle into the same global coordinate system as the three-dimensional location coordinates of the first target point. A stable and accurate three-dimensional model of the road and/or three-dimensional location coordinates of the vehicle is thereby obtained.

According to a further embodiment, the lateral distance is calculated in the cartesian coordinates of the first and second target point and, as a next step, transformed as three-dimensional location coordinates of the vehicle to obtain a three-dimensional model of the road. Once the first and second target point are determined, the lateral deviation between both can be precisely generated.

According to another aspect, a computer program element is provided. The computer program element comprises instructions which, when the program element is executed by a computer, causes the computer to carry out the method according to one or more of the method steps discussed above.

According to yet another aspect, a computer-readable medium is provided. The computer-readable medium comprises instructions which, when executed by a computer, causes the computer to carry out the method according to one or more of the method steps discussed above.

According to yet another aspect, a driver assistance system for a vehicle is provided. The driver assistance system is configured to control the vehicle autonomously or semi-autonomously. This means that vehicle guidance is taken over by the vehicle itself at least in part. In particular, this involves vehicles with an SAE (Society of Automotive Engineers) level of automation of level 2 or higher. For example, the driver assistance system may comprise an automated lane centering assist, an active lane change assist, an adaptive cruise control, an emergency steering assist.

The driver assistance system comprises a vehicle sensor unit to detect a roadway of the driven vehicle. The vehicle sensor unit may comprise at least one camera, radar, lidar and/or ultrasonic sensor. Further, the driver assistance system comprises a control unit to receive, at least from the vehicle sensor unit, sensor data corresponding to the roadway of the driven vehicle. In particular, the control unit is configured to control the speed and/or the steering of the vehicle.

The control unit is configured to determine a first target point ahead of the driven vehicle. The first target point determination may be distance-based or time-based. Moreover, the determination of the first target point determination can be based on different factors like planning strategy or system delays. For example, the first target point is determined 2 seconds ahead on a specific ego current speed of 40 m/s.

The control unit is configured to determine a second target point lying on the same lateral plane as the first target point when the vehicle has travelled for a certain time after the time of the determined first target point and/or the control unit is configured to determine the second target point lying on the same lateral plane as the first target point when the vehicle has travelled a predefined longitudinal distance.

The control unit is configured to calculate a lateral distance between the determined first and second target point and to compare the calculated lateral distance with at least a first predefined threshold. Further, the control unit is configured to determine a path tracking error if the calculated lateral distance exceeds at least the first predefined threshold. The lower the distance between vehicle and target point, the higher the image resolution and the higher the determined target point accuracy. Thus, the comparison of the first and second determined target point allows an efficient lane model consistency check.

By exceeding the at least first predefined threshold, a stable and accurate lane model in lane tracking cannot be ensured anymore. Therefore, the control unit is configured to provide a control signal to a steering controller in dependence of the determined tracking error. For example, the steering and/or speed control will be terminated in due time if the tracking error exceeds the at least first predefined threshold.

In particular, the control unit may comprise a microcontroller or processor, a central processing unit (CPU), a graphics processing unit (GPU), a digital signal processor (DSP), an ASIC (application specific integrated circuit), an FPGA (field programmable gate array), and the like, as well as software for performing the corresponding process steps. Thus, an aspect of the present invention may be implemented in digital electronic circuits, computer hardware, firmware, or software.

### BRIEF DESCRIPTION OF THE DRAWINGS

Exemplary embodiments of the invention will be described in the following with reference to the following drawings.

FIG. 1 shows a schematic top view on an illustrative vehicle with a driver assistance system according to an embodiment of the invention;

FIG. 2 shows a flowchart of a method for a computer-implemented method for providing steering control for an autonomously driven or semi-autonomously driven vehicle according to an embodiment of the invention.

### DETAILED DESCRIPTION OF EXEMPLARY EMBODIMENTS

The accompanying drawings are included to provide a further understanding of an aspect of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

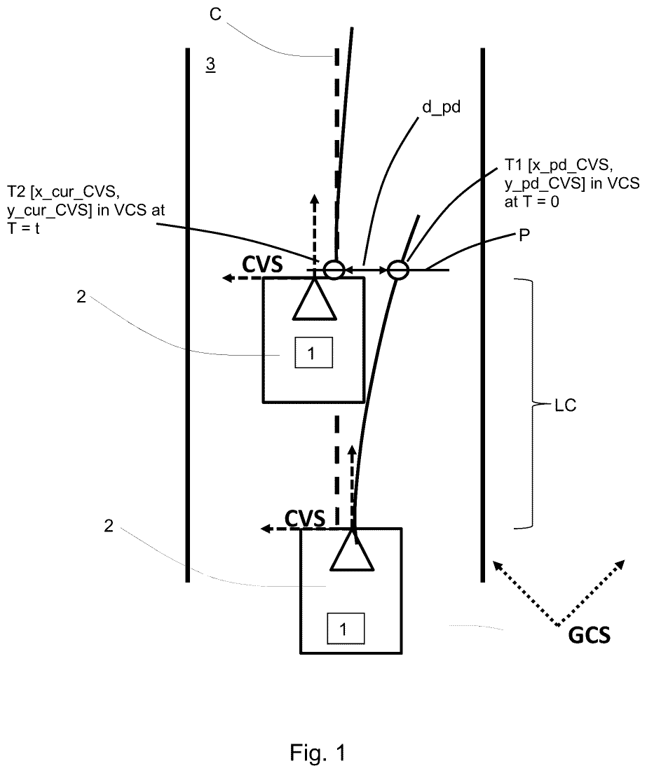

FIG. 1 is a top view showing a driver assistance system 1 for an autonomous or semi-autonomous control of a vehicle 2 driving along a lane 3. The driver assistance system 1 comprises a control unit which may be used in order to control driving functions or a system for automated driving like a lane keeping system, an adaptive cruise control system, an autonomous emergency braking system, a construction site assistant, a traffic jam assistant, a highway chauffeur or an autopilot function for a vehicle. In this embodiment, the driver assistance system 1 is a lane keeping assist which is adapted to guide the vehicle 2 along a centerline C of the ego-lane 3.

The driver assistance system 1 comprises a vehicle sensor unit to detect a roadway of the driven vehicle 2. The sensor unit may comprise one or more cameras. The control unit is configured to receive, at least from the vehicle sensor unit, sensor data corresponding to the roadway of the driven vehicle 2. In addition, information corresponding to the roadway of the driven vehicle 2 may be obtained via car-to-x and/or car-to-car communication.

As a next step, the control unit is configured to determine a first target point T1 ahead of the driven vehicle 2 at time T=0. The first, second and further determined target points are waypoints indicating a planned vehicle path of travel. The first target point T1 is determined as cartesian coordinates x_previewdistance_CVS and y_previewdistance_CVS and may be transformed into a global coordinate system x_previewdistance_GCS and y_previewdistance_GCS as three-dimensional location coordinates of the vehicle 2. In particular, the determined first, second and further target points is based on odometry data of the driven vehicle.

Because of the difficulty in accurately lane tracking at large distances from the vehicle (e.g. greater than 60 meters), a lane model consistency check will be done as follows. The control unit is configured to determine a second target point T2 lying on the same lateral plane P as the first target point when the vehicle 2 has travelled for a certain time after the time of the determined first target point T1. So, in this embodiment, the vehicle 2 has travelled a predefined time T=t after the determination time T=0 of first target point T1. Alternatively, or in addition, the control unit is configured to determine the second target point T2 lying on the same lateral plane P as the first target point T1 when the vehicle 2 has travelled a predefined longitudinal distance LC. The predefined longitudinal distance LC may be configured in such a way that, when the second target point T2 is measured, the vehicle 2 is at least close to the location, e.g. less than 1 meter by using odometry, of the determined first target point T1. The lateral plane P is laterally oriented to the direction of the ego-lane 3, in particular perpendicular to the lane direction.

The control unit is configured to calculate a lateral distance d_pd, in particular the cartesian lateral distance d_pd between the determined first and second target point T1, T2. The calculated lateral distance d_pd will be compared with at least a first predefined threshold. In order to perform an image-based three-dimensional lane detection, the first and second cartesian target point T1, T2 may be transformed into a global coordinate system GCS as three-dimensional location coordinates T1 x_pd_GCS, y_pd_GCS and T2 x_current_GCS, y_current_GCS.

As a next step, the control unit is configured to determine a path tracking error if the calculated lateral distance exceeds at least the first predefined threshold. According to FIG. 1, the first and second target point T1, T2 do have a lateral distance d_pd to each other. Further, the control unit is configured to provide a control signal to a steering controller in dependence of the determined tracking error. In this embodiment, the lateral distance d_pd exceeds at least the first predefined threshold. Based on this result, according to this embodiment, the adaptive lane centering may be degraded based on the lane model consistency check fulfilled by the determined tracking error. As an advantage, the control for an autonomously driven or semi-autonomously driven vehicle will provided only with a stable and accurate lane tracking. However, as another exemplary embodiment, the determined lateral distance d_pd may be compared at least with a second predefined threshold, which is more restrictive than the first predefined threshold. If the lateral distance d_pd exceeds the first predefined threshold, the automatic or semi-automated control may be restricted, wherein if the lateral distance d_pd exceeds the second predefined threshold, the automatic or semi-automated control may be terminated. Once the determined lateral distance d_pd is below the first threshold, the lane model may again be used for automated driving functions.

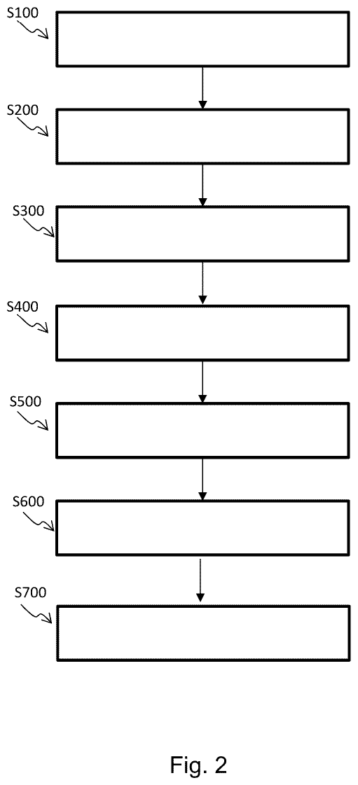

FIG. 2 shows a flow chart diagram of a computer-implemented method for providing steering control for an autonomously driven or semi-autonomously driven vehicle according to an embodiment. The method comprises as a first step to receive, from at least one vehicle sensor, sensor data corresponding to a roadway of the driven vehicle S100. A a first target point T1 ahead of the driven vehicle 2 is determined S200, wherein a second target point T2 lying on the same lateral plane P as the first target point T1 is determined when the vehicle 2 has travelled for a certain time after the time of the determined first target point T1 and/or determining the second target point T2 lying on the same lateral plane P as the first target point T1 when the vehicle 2 has travelled a predefined longitudinal distance LC S300. In particular, the second target point is determined in a region that is close to the vehicle 2. As a next step, S400 a lateral distance between the determined first and second target point is calculated, and the calculated lateral distance d_pd is compared with at least a first predefined threshold S500. A path tracking error is determined if the calculated lateral distance exceeds at least the first predefined threshold S600. As a next step, a control signal to a steering controller is provided in dependence of the determined tracking error S700. Those skilled in the art will recognize that the lane model consistency steps may be done once or multiple times. As another embodiment, the lateral distance d_pd may be calculated upon collection of iterative or average determined target points T1, T2.

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. A single processor or other unit may fulfil the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

1. A computer-implemented method for providing steering control for an autonomously driven or semi-autonomously driven vehicle the method comprising the steps:
receiving, from at least one vehicle sensor, sensor data corresponding to a roadway of the driven vehicle
determining a first target point ahead of the driven vehicle determining a second target point lying on the same lateral plane as the first target point when the vehicle has travelled for a certain time after the time of the determined first target point and/or determining the second target point lying on the same lateral plane as the first target point when the vehicle has travelled a predefined longitudinal distance,
calculating a lateral distance between the determined first and second target point,
comparing the calculated lateral distance with at least a first predefined threshold,
a path tracking error is determined if the calculated lateral distance exceeds at least the first predefined threshold providing a control signal to a steering controller in dependence of the determined tracking error.

2. The method according to claim 1, wherein the calculated lateral distance is compared with at least a second predefined threshold, wherein the second predefined threshold is higher than the first predefined threshold, wherein a first steering control signal is provided, if the first predefined threshold exceeds, wherein a second steering control signal is provided, if the second predefined threshold exceeds, wherein the first and second predefined control signal differ at least in part from each other.

3. The method according to claim 1, wherein a hand-off time of the steering wheel will be reduced and/or the driver will be informed that the current steering control system might not be stable and/or a threshold for intervention in the steering control system by the driver will be reduced if the calculated lateral distance exceeds the first predefined threshold for longer than a predefined time.

4. The method according to claim 2, wherein the driver will receive a take-over request and/or the steering control will be ended in a predefined time if the calculated lateral distance exceeds the second predefined threshold for longer than a predefined time.

5. The method according to claim 1, wherein the first target point is received and stored from a lane model as lateral and longitudinal cartesian coordinates wherein the first cartesian target point is transformed into a global coordinate system as three-dimensional location coordinates of the vehicle.

6. The method according to claim 5, wherein the second target point is received and stored from the lane model as lateral and longitudinal cartesian coordinates, wherein the second cartesian target point is transformed as three-dimensional location coordinates of the vehicle into the same global coordinate system as the three-dimensional location coordinates of the first target point.

7. The method according to claim 5, wherein the lateral distance is calculated in the cartesian coordinates of the first and second target point and, as a next step, transformed as three-dimensional location coordinates of the vehicle to obtain a three-dimensional model of the road.

8. A computer program element, comprising instructions which, when the program element is executed by a computer, cause the computer to carry out the method of claim 1.

9. A non-transitory computer-readable medium comprising instructions which, when executed by a computer, cause the computer to carry out the method of any of claim 1.

10. A driver assistance system for a vehicle comprising:
a vehicle sensor unit to detect a roadway of the driven vehicle,
a control unit to receive, at least from the vehicle sensor unit, sensor data corresponding to the roadway of the driven vehicle,
wherein the control unit is configured to determine a first target point ahead of the driven vehicle,
wherein the control unit is configured to determine a second target point lying on the same lateral plane as the first target point when the vehicle has travelled for a certain time after the time of the determined first target point and/or configured to determine the second target point lying on the same lateral plane as the first target point when the vehicle has travelled a predefined longitudinal distance,
wherein the control unit is configured to calculate a lateral distance between the determined first and second target point and to compare the calculated lateral distance with at least a first predefined threshold,
wherein the control unit is configured to determine a path tracking error if the calculated lateral distance exceeds at least the first predefined threshold,
wherein the control unit is configured to provide a control signal to a steering controller in dependence of the determined tracking error.

11. A vehicle comprising a driver assistance system according to claim 10.

12. The method according to claim 3, wherein the driver will receive a take-over request and/or the steering control will be ended in a predefined time if the calculated lateral distance exceeds the second predefined threshold for longer than a predefined time.

13. The method according to claim 6, wherein the lateral distance is calculated in the cartesian coordinates of the first and second target point and, as a next step, transformed as three-dimensional location coordinates of the vehicle to obtain a three-dimensional model of the road.
